(19) United States
(12) Patent Application Publication
(10) Pub. No.: US 2026/0238856 A1
(43) Pub. Date: Aug. 13, 2026

(54) DISPLAY APPARATUS FOR DISPLAYING SHORT-FORM CONTENTS AND CONTROL METHOD THEREOF

(71) Applicant: SAMSUNG ELECTRONICS CO., LTD., Suwon-si (KR)

(72) Inventors: Yeeun SHIN, Suwon-si (KR); Boyoon HUR, Suwon-si (KR); Junpyo HONG, Suwon-si (KR); Ahyeon SHIM, Suwon-si (KR); Jangwon SEO, Suwon-si (KR); Eunhee PARK, Suwon-si (KR)

(73) Assignee: SAMSUNG ELECTRONICS CO., LTD., Suwon-si (KR)

(21) Appl. No.: 19/565,076

(22) Filed: Mar. 12, 2026

Related U.S. Application Data
(63) Continuation of application No. PCT/KR2026/001995, filed on Feb. 3, 2026.

(30) Foreign Application Priority Data
Feb. 12, 2025 (KR) 10-2025-0017919

(51) Int. Cl. H04N 21/472; H04N 21/431; H04N 21/482; H04N 21/845

(52) U.S. Cl. CPC H04N 21/47217; H04N 21/4318; H04N 21/4825; H04N 21/8456

(57) ABSTRACT

A display apparatus includes: a display; memory storing instructions; and at least one processor which executes the instructions to cause the display apparatus to: divide short-form contents into groups, generate playlists corresponding to the groups, display an interface screen for sequentially playing back short-form contents included in each playlist, each playlist corresponding to an area of the interface screen, identify, based on a graphic interface being displayed in an area, whether an aspect ratio of a short-form content displayed in the area corresponds to a ratio of the area, and based on the aspect ratio corresponding to the ratio of the area, playback the short-form content in the area, and based on the aspect ratio not corresponding to the ratio of the area, crop the short-form content and playback the cropped short-form content in a portion of the area, or playback the short-form content in a portion of the area.

### CROSS-REFERENCE TO RELATED APPLICATIONS

This application is a bypass continuation application of International Application No. PCT/KR2026/001995, filed on Feb. 3, 2026, which claims priority to Korean Patent Application No. 10-2025-0017919, filed on Feb. 12, 2025, in the Korean Intellectual Property Office, the disclosures of which are incorporated by reference herein in their entireties.

### BACKGROUND

### 1. Field

The disclosure relates to a display that displays short-form images and a control method thereof.

### 2. Description of Related Art

With developments in over-the-top (OTT) service, there is a growing tendency of users first viewing short-form content associated with movies or series and then determining which long-form content (e.g., movie) to watch.

Short-form images or content and user interfaces for viewing the short-form content have been generated under the assumption of being viewed through smartphones. Accordingly, there has been an absence of user interfaces for viewing short-form content on large-scale displays such as TVs. As such, there has been a growing need for a user interface capable of viewing short-form content in large-scale displays.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

According to an aspect of the disclosure, a display apparatus includes: a display; memory storing instructions; and at least one processor including processing circuitry, wherein the instructions, when executed by the at least one processor individually or collectively, cause the display apparatus to: divide a plurality of short-form contents into a plurality of groups, generate a plurality of playlists, wherein each playlist of the plurality of playlists corresponds to a group of the plurality of groups, display an interface screen for sequentially playing back short-form contents included in each playlist of the plurality of playlists, wherein each playlist of the plurality of playlists corresponds to an area of a plurality of areas of the interface screen on the display, identify, based on a graphic interface being displayed in an area of the plurality of areas, whether an aspect ratio of a short-form content displayed in the area corresponds to a ratio of the area, and based on the aspect ratio of the short-form content corresponding to the ratio of the area, playback the short-form content in the area, and based on the aspect ratio of the short-form content not corresponding to the ratio of the area, (i) crop the short-form content and playback the cropped short-form content in a portion of the area, or (ii) playback the short-form content in a portion of the area.

The instructions, when executed by the at least one processor individually or collectively, may cause the display apparatus to: based on the aspect ratio of the short-form content and the ratio of the area being the same, identify the aspect ratio of the short-form content as corresponding to the ratio of the area, or based on the aspect ratio of the short-form content and the ratio of the area being different, identify the aspect ratio of the short-form content as not corresponding to the ratio of the area.

The instructions, when executed by the at least one processor individually or collectively, may cause the display apparatus to: based on the aspect ratio of the short-form content not corresponding to a ratio of the area, and the aspect ratio of the short-form content being a first aspect ratio, playback the short-form content in a portion of the area, and based on the aspect ratio of the short-form content not corresponding to a ratio of the area, and the aspect ratio of the short-form content being a second aspect ratio, crop the short-form content and playback the cropped short-form content in a portion of the area.

The instructions, when executed by the at least one processor individually or collectively, may cause the display apparatus to input the short-form content into a trained artificial intelligence model to crop the short-form content such that an object included in the short-form content is to be included in the cropped short-form content, and obtain the cropped short-form content from the artificial intelligence model.

The instructions, when executed by the at least one processor individually or collectively, may cause the display apparatus to: display a plurality of thumbnail images in the plurality of areas, wherein each thumbnail image of the plurality of thumbnail images corresponds to a short-form content included in the plurality of playlists, and based on the graphic interface being displayed in the area, playback the short-form content which corresponds to a thumbnail image displayed in the area at the area.

The instructions, when executed by the at least one processor individually or collectively, may cause the display apparatus to: playback, while the graphic interface is being displayed in the area, the short-form content for a pre-set time, wherein the short-form content is included in a playlist of the plurality of playlists, and after the pre-set time, playback a second short-form content in the area, wherein the second short-form content is included in the playlist.

The instructions, when executed by the at least one processor individually or collectively, may cause the display apparatus to, based on the graphic interface being displayed in the area, display at least one from among a number of short-form contents included in a playlist corresponding to the area and a title of a short-form content being played back in the area on a short-form content displayed in the area .

The instructions, when executed by the at least one processor individually or collectively, may cause the display apparatus to, based on a user input for selecting the area in which the graphic interface is displayed being received, playback the short-form content displayed in the area on a screen of the display.

The instructions, when executed by the at least one processor individually or collectively, may cause the display apparatus to display at least one from among a title of a playlist in which the short-form content is included, a title of the short-form content, a progress bar for the short-form content, an interface element for playing back an image associated with the short-form content, and an interface element for inputting a preference indication about the short-form content on the screen.

The instructions, when executed by the at least one processor individually or collectively, may cause the display apparatus to, based on a user input for playing back another short-form content that is different from the short-form content being received, playback a second short-form content included in a first playlist in which the short-form content is included on a screen of the display, or playback a third short-form content included in a second playlist that is different from the first playlist on the screen.

According to an aspect of the disclosure, a control method of a display apparatus, includes: dividing a plurality of short-form contents into a plurality of groups; generating a plurality of playlists, wherein each playlist of the plurality of playlists corresponds to a group of the plurality of groups; displaying an interface screen for sequentially playing back short-form contents included in each playlist of the plurality of playlists, wherein each playlist of the plurality of playlists corresponds to an area of a plurality of areas of the interface screen on a display; based on a graphic interface being displayed in an area of the plurality of areas, identifying whether an aspect ratio of a short-form content displayed in the area corresponds to a ratio of the area; based on the aspect ratio of the short-form content corresponding to the ratio of the area, playing back the short-form content in the area; and based on the aspect ratio of the short-form content not corresponding to the ratio of the area, (i) cropping the short-form content and playing back the cropped short-form content in a portion of the area or (ii) playing back the short-form content in a portion of the area.

The identifying whether the aspect ratio of the short-form content displayed in the area corresponds to the ratio of the area may include: based on the aspect ratio of the short-form content and the ratio of the area being the same, identifying the aspect ratio of the short-form content as corresponding to the ratio of the area; and identifying, based on the aspect ratio of the short-form content and the ratio of the area being different, the aspect ratio of the short-form content as not corresponding to the ratio of the area.

The playing back the short-form content in a portion of the area, or cropping the short-form content and playing back the cropped short-form content in a portion of the area may include: based on the aspect ratio of the short-form content not corresponding to the ratio of the area and the aspect ratio of the short-form content being a first aspect ratio, playing back the short-form content in the portion of the area, and based on the aspect ratio of the short-form content not corresponding to the ratio of the area and the aspect ratio of the short-form content being a second aspect ratio, cropping the short-form content and playing back the cropped short-form content in the portion of the area.

The cropping the short-form content includes inputting the short-form content into a trained artificial intelligence model to crop the short-form content such that an object included in the short-form content is to be included in the cropped short-form content.

The control method may further include: displaying a plurality of thumbnail images in the plurality of areas, wherein each thumbnail image of the plurality of thumbnail images corresponds to a short form content included in the plurality of playlists, and based on the graphic interface being displayed in the area, playing back the short-form content which corresponds to a thumbnail image displayed in the area at the area.

According to an aspect of the disclosure, a non-transitory computer-readable recording medium stores one or more instructions executed by a processor of a display apparatus to may cause the display apparatus to perform a method including: dividing a plurality of short-form contents into a plurality of groups; generating a plurality of playlists, wherein each playlist of the plurality of playlists corresponds to a group of the plurality of groups; displaying an interface screen for sequentially playing back short-form contents included in each playlist of the plurality of playlists, wherein each playlist of the plurality of playlists corresponds to an area of a plurality of areas of the interface screen on a display; based on a graphic interface being displayed in an area of the plurality of areas, identifying whether an aspect ratio of a short-form content displayed in the area corresponds to a ratio of the area; based on the aspect ratio of the short-form content corresponding to the ratio of the area, playing back the short-form content in the area; and based on the aspect ratio of the short-form content not corresponding to the ratio of the area, (i) cropping the short-form content and playing back the cropped short-form content in a portion of the area or (ii) playing back the short-form content in a portion of the area.

To further clarify the advantages and features of the present disclosure, a more particular description of the disclosure will be rendered by reference to specific embodiments thereof, which is illustrated in the appended drawing. It is appreciated that these drawings depict only typical embodiments of the disclosure and are therefore not to be considered limiting its scope. The disclosure will be described and explained with additional specificity and detail with the accompanying drawings.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram illustrating an operation of a display apparatus according to at least one embodiment of the disclosure;

FIG. 2 is a block diagram illustrating a configuration of a display apparatus according to at least one embodiment of the disclosure;

FIG. 3 is a block diagram illustrating a detailed configuration of a display apparatus according to at least one embodiment of the disclosure;

FIG. 4 is a flowchart illustrating an operation of a display apparatus according to at least one embodiment of the disclosure;

FIG. 5 is a diagram illustrating a method by which a display apparatus displays a thumbnail in an area according to at least one embodiment of the disclosure;

FIG. 6A and 6B are diagrams illustrating an operation of an image displayed in an area being played back according to at least one embodiment of the disclosure;

FIG. 7 is a diagram illustrating an area having various ratios according to at least one embodiment of the disclosure;

FIGS. 8A, 8B, and 8C are diagrams illustrating a method by which images of various aspect ratios are displayed in an area according to at least one embodiment of the disclosure;

FIGS. 9A, 9B, and 9C are diagrams illustrating specific examples in which images of various aspect ratios are displayed in an area according to at least one embodiment of the disclosure;

FIGS. 10, 11, and 12 are diagrams illustrating user interface screens through which short-form content can be viewed in a large-scale display screen according to at least one embodiment of the disclosure; and

FIGS. 13 and 14 are diagrams illustrating a method for converting a short-form content to a different short-form content according to at least one embodiment of the disclosure.

### DETAILED DESCRIPTION

The disclosure will be described in detail below with reference to the accompanying drawings.

Various embodiments of the disclosure and terms used herein are not intended to limit the technical features described in the disclosure to specific embodiments, and it is to be understood as including various modifications, equivalents, or alternatives of relevant embodiments. With respect to the description of the drawings, like reference numerals may be used for like or associated elements. A singular form of a noun corresponding to an item may include one or a plurality of items above, unless otherwise specified. In the disclosure, phrases such as “A or B”, “at least one of A and B”, “at least one of A or B”, “A, B, or C”, “at least one of A, B, and C”, and “at least one of A, B, or C” may respectively include any one from among the items listed together in a relevant phrase, or include all possible combinations thereof from among the phrases. Terms such as “1st”, “2nd”, or “first” or “second” may be used to simply distinguish a relevant element from another relevant element, and not limit the relevant elements in other aspects (e.g., importance or order). When a certain (e.g., first) element is indicated as being “coupled with/to” or “connected to” another (e.g., second) element, together with or without terms such as “operatively” or “communicatively”, it may be understood as the certain element being coupled with/to the another element directly (e.g., via wire), wirelessly, or through a third element.

In the drawings, like reference numerals refer to like elements.

Through the disclosure, a singular expression includes a plural expression, unless otherwise specified. Throughout the disclosure, when a certain portion is described as “including” a certain element, the above may mean that another element may be further included rather than excluding the another element, unless otherwise specified.

The term “module” used in various embodiments of the disclosure may include a unit implemented with hardware, software, or firmware, and may be used interchangeably with terms such as, for example, logic, logic blocks, components, or circuitry. A module may be a component integrally formed or a minimum unit or a part of the component performing one or more functions. For example, according to an embodiment, a module may be implemented in a form of an application-specific integrated circuit (ASIC).

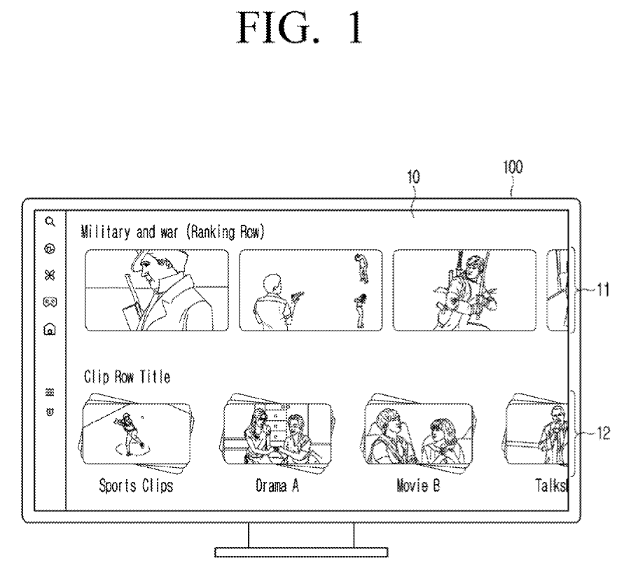

FIG. 1 is a diagram illustrating an operation of a display apparatus according to at least one embodiment of the disclosure.

In an embodiment, a display apparatus 100 may be implemented as a television (TV). For example, the display apparatus 100 may be a light emitting diode (LED) TV, an organic light emitting diode (OLED) TV, a quantum dot light emitting diode (QLED) TV, a quantum dot TV, or a digital signage device (e.g., an LED display module arranged as one or in a matrix form). In addition, the display apparatus 100 may be a TV having a flat screen, a curved TV having a screen of fixed curvature, or a curvature variable TV having a changeable curvature. However, the disclosure is not limited thereto, and a device including a display such as a computer, a tablet, a smartphone, and the like may be an example of the display apparatus 100 according to the disclosure.

In an embodiment, the display apparatus 100 may display an interface screen.

The interface screen may be a screen that categorizes and provides a plurality of content according to category. For example, the categories may include genres, themes, user activities (e.g., viewing record, evaluation, whether viewing is completed, etc.), popular/trending, viewing ratings, cast members, production crew, and the like. A user may be provided with visualized and hierarchical information about content viewable by the user through the interface screen, and more easily and quickly search for content to be viewed.

For example, the display apparatus 100 may display, when the user selects a content through the interface screen, an image about the content on a screen of the display apparatus 100 by playing back the content. The display apparatus 100 may also output an audio signal for the content through a speaker. The content may be stored in the display apparatus 100 or streamed from a server in communication with the display apparatus 100.

In an embodiment, the content may include an original copy content and a short-form content.

The original copy content may be a content that is a basis for producing the short-form content. The original copy content may be content of a complete form that includes an overall story and context. For example, the original copy content may include an episode or one season of a movie, a drama, and a documentary, a full broadcast images of a sports game, and the like. The original copy content may be substituted with expressions, such as, for example, and without limitation, a long-form content, a full-length content, a source content, and the like.

The short-form content may be content of a short length derived from the original copy content. For example, the short-form content may include content edited to a short length by extracting specific scenes, themes, or key content of the original copy content. In addition, the short-form content may include content of a short length produced for a specific purpose such as promoting the original copy content or providing summary information of the original copy content. For example, the short-form content may include trailers that utilized specific scenes in a movie, interviews carried out with cast members of a movie, sport games or specific scenes in a drama, and content produced by editing the specific scenes. The short-form content may be substituted with expressions such as, for example, highlight content or clips.

The interface screen may display original copy contents categorized according to categories. For example, referring to FIG. 1, an interface screen 10 may display thumbnails 11 of movies having a war theme. In addition, the interface screen may display short-form contents categorized according to category. For example, referring to FIG. 1, the display apparatus 100 may distinguish the short-form contents to short-form contents associated with sports, to short-form contents about drama A, to short-form contents about movie B, and to short-form contents associated with talk-shows. The display apparatus 100 may display thumbnails 12 of the categorized short-form contents on the interface screen 10.

As described, according to the disclosure, the display apparatus 100 may categorize and provide short-form contents through the interface screen, playback the short-form contents and provide to the user, and the above will be described in greater detail below.

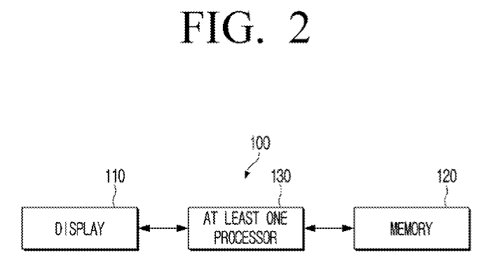

FIG. 2 is a block diagram illustrating a configuration of the display apparatus 100 according to at least one embodiment of the disclosure.

Referring to FIG. 2, the display apparatus 100 according to the disclosure may include a display 110, memory 120, and at least one processor 130 (hereinafter, referred to as ‘processor 130’).

The display 110 may be controlled by the processor 130, and configured to output visualized information to the user. The visualized information may include visualized elements displayed on the display 110. For example, a visualized object may include a screen, an image, an icon, a graphic user interface (GUI), and/or a user interface (UI) element.

The processor 130 may display various notifications, messages, information, and the like associated with an operation of the display apparatus 100 on the display 110.

The display 110 may be implemented as a display including self-emissive elements or a display including non-emissive elements and a backlight. For example, the display 110 may be implemented as displays of various forms such as, for example, and without limitation, a liquid crystal display (LCD), an organic light emitting diode (OLED) display, a light emitting diode (LED) display, micro LED display, a Mini LED display, a Quantum dot light-emitting diode (QLED) display, and the like.

The memory 120 may be implemented as a memory embedded in the display apparatus 100 according to data storage use (e.g., a volatile memory (e.g., a semi-permanent memory such as a random access memory (RAM)), a non-volatile memory (e.g., a permanent memory such as a read-only memory (ROM)), a flash memory, a hard drive or a solid state drive, etc.), or implemented as a memory attachable to or detachable from the display apparatus 100 (e.g., a memory card, an external memory, etc.).

The memory 120 may be stored with instructions. The processor 130 may perform, by individually or collectively executing the instructions in the memory 120, an operation of the display apparatus 100 according to various embodiments of the disclosure. In addition, the memory 120 may be stored with programs and data for driving the display apparatus 100. For example, the memory 120 may store an operating system (or system) software application, a firmware software application, a driver software application, a plug-in (e.g., add-in, add-on, and/or applet) software application, and/or one or more software applications such as any other suitable software applications.

Meanwhile, in the disclosure, the term ‘memory 120’ may be used as a meaning that includes the memory 120, the ROM and RAM in the processor 130, or a memory card (e.g., a micro SD card, a memory stick) mounted in the display apparatus 100. In addition thereto, various information necessary within an extent for achieving an object of the disclosure may be stored in the memory 120, and information stored in the memory 120 may be received from an external device or updated according to being input by the user.

The processor 130 may control operations of the display apparatus 100 overall. For example, the processor 130 may cause other elements of the display apparatus 100 to perform various operations buy executing the instructions stored in the memory 120. For example, the processor 130 may be operatively connected with the memory 120, and control an operation of the display apparatus 100. In addition, the processor 130 may control, by executing one or more instructions stored in the memory 120, an operation of the display apparatus 100 according to the disclosure. The processor 130 may be configured with one or a plurality of processors.

The processor 130 may be implemented with one or more integrated circuit (or circuitry) (IC) chips, and may execute various data processing. The processor 130 may include at least one electrical circuit, and individually and collectively distribute and process the instructions (or programs, data, others, etc.) stored in the memory 120. The processor 130 may include a processor assembly including one or more processing circuitry. The processor 130 may include any operative processing circuitry for controlling performances and operations of one or more elements (e.g., memory 120) of the display apparatus 100. For example, the processor 130 (e.g., application processor (AP)) may be implemented as a system on chip (SoC) (e.g., one chip or a chip set). For example, the processor 130 may be implemented as a plurality of cores (or at least one core circuit), a plurality of chips, or a plurality of chip sets. For example, the processor 130 may include one or more processing circuitry. For example, the processor 130 may include one or more processing circuitry configured to individually and/or collectively perform several functions of the disclosure.

The processor 130 may include one or more from among a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The processor 130 may control one or a random combination from among other elements of the display apparatus 100, and perform an operation associated with communication or data processing. The processor 130 may execute one or more programs or instructions stored in the memory 120 of the display apparatus 100. For example, the processor 130 may perform, by executing one or more instruction stored in the memory 120, a method according to an embodiment of the disclosure.

When a method according to an embodiment of the disclosure includes a plurality of operations, the plurality of operations may be performed by one processor, or performed by a plurality of processors. For example, when a first operation, a second operation, and a third operation are performed by a method according to an embodiment, the first operation, the second operation, and the third operation may all be performed by a first processor, or the first operation and the second operation may be performed by the first processor (e.g., a generic-purpose processor) and the third operation may be performed by a second processor (e.g., an artificial intelligence dedicated processor).

The processor 130 may be implemented as a single core processor that includes one core, or implemented as one or more multicore processors that include a plurality of cores (e.g., a homogeneous multicore or a heterogeneous multicore). If the processor 130 is implemented as multicore processors, each of the plurality of cores included in the multicore processors may include a memory inside the processor such as a cache memory and an on-chip memory, and a common cache shared by the plurality of cores may be included in the multicore processors. In addition, each of the plurality of cores (or a portion from among the plurality of cores) included in the multicore processors may independently read and perform a program command for implementing a method according to an embodiment of the disclosure, or read and perform a program command for implementing a method according to an embodiment of the disclosure due to a whole (or a portion) of the plurality of cores being interconnected.

When a method according to an embodiment of the disclosure includes a plurality of operations, the plurality of operations may be performed by one core from among the plurality of cores or performed by the plurality of cores included in the multicore processors. For example, when a first operation, a second operation, and a third operation are performed by a method according to an embodiment, the first operation, the second operation, and the third operation may all be performed by a first core included in the multicore processors, or the first operation and the second operation may be performed by the first core included in the multicore processors and the third operation may be performed by a second core included in the multicore processors.

In the embodiments of the disclosure, the processor may refer to a system on chip (SoC), a single core processor, or multicore processors in which one or more processors and other electronic components are integrated or a core included in the single core processor or the multicore processor, and the core herein may be implemented as the CPU, the GPU, the APU, the MIC, the DSP, the NPU, the hardware accelerator, the machine learning accelerator, or the like, but the embodiments of the disclosure are not limited thereto.

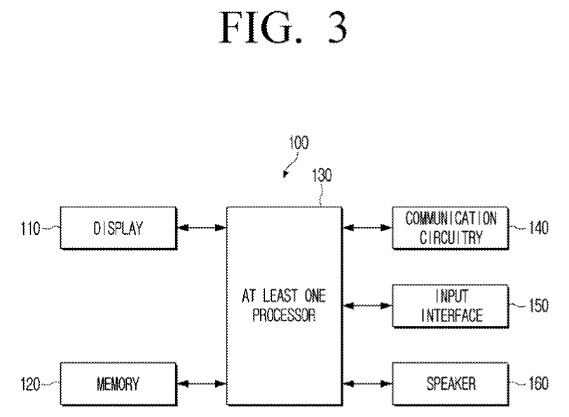

FIG. 3 is a block diagram illustrating a detailed configuration of a display apparatus according to at least one embodiment of the disclosure.

Referring to FIG. 3, the display apparatus 100 may include the display 110, the memory 120, at least one processor 130, communication circuitry 140, an input interface 150, and a speaker 160.

However, the configurations as described above are merely examples, and a new configuration may be added or a portion of the configurations may be omitted in addition to the above-described configurations in implementing the disclosure. Meanwhile, detailed descriptions on configurations that overlap with the configurations shown in FIG. 2 from among the configurations shown in FIG. 3 will be omitted.

By control of the processor 130, data communication with an external electronic apparatus may be performed. The external electronic apparatus may include servers, home appliances, mobile devices (e.g., smartphones, tablet personal computers (PC), wearable devices, etc.). The communication circuitry 140 may perform, by control of the processor 130, data communication with the external electronic apparatus (e.g., server, home appliance, mobile devices, etc.). For example, the communication circuitry 140 may communicate with the external electronic apparatus through a network. For example, the processor 130 may receive data from the external electronic apparatus through the communication circuitry 140, and transmit data to the external electronic apparatus through the communication circuitry 140.

The communication circuitry 140 may include hardware components for supporting transmission and/or reception of electrical signals between the display apparatus 100 and the external electronic apparatus. For example, the communication circuitry 140 may use at least one from among data communication methods that include wired local area network (LAN), wireless LAN, Wi-Fi, Wi-Fi Direct, Bluetooth, ZigBee, Wi-Fi Direct (WFD), infrared communication (infrared Data Association (IrDA)), Bluetooth Low Energy (BLE), Near Field Communication (NFC), Wireless Broadband Internet (Wibro), World Interoperability for Microwave Access (WiMAX), Shared Wireless Access Protocol (SWAP), Wireless Gigabit Alliances (WiGig), and RF communication, and perform data communication between the display apparatus 100 and an electronic apparatus. The communication circuitry 140 may also be described as a communication interface.

The input interface 150 may include circuitry. The input interface 150 may receive a user input, and transfer the user input to the processor 130. For example, the input interface 150 may receive various user inputs for setting or selecting various functions supported in the display apparatus 100.

The input interface 150 may include input devices of various types.

According to an embodiment, the input interface 150 may include a physical button. The physical button may include a function key or a dial button. The physical button may be implemented as one or more keys.

According to an example, the input interface 150 may receive a user input using a touch method. For example, the input interface 150 may be implemented as a touch screen capable of performing a function of the display 110.

According to an example, the input interface 150 may receive a user voice using a microphone. The processor 130 may perform a function corresponding to the user voice using voice recognition. For example, the processor 130 may convert the user voice to text data using a Speech to Text (STT) function, obtain control command data based on the text data, and perform a function corresponding to the user voice based on the control command data. According to an embodiment, the STT function may be performed from an external server.

The speaker 160 may output audio signals. The processor 130 may output warning sounds associated with an operation of the display apparatus 100, notification messages, response messages corresponding to the user inputs, and the like through the speaker 160.

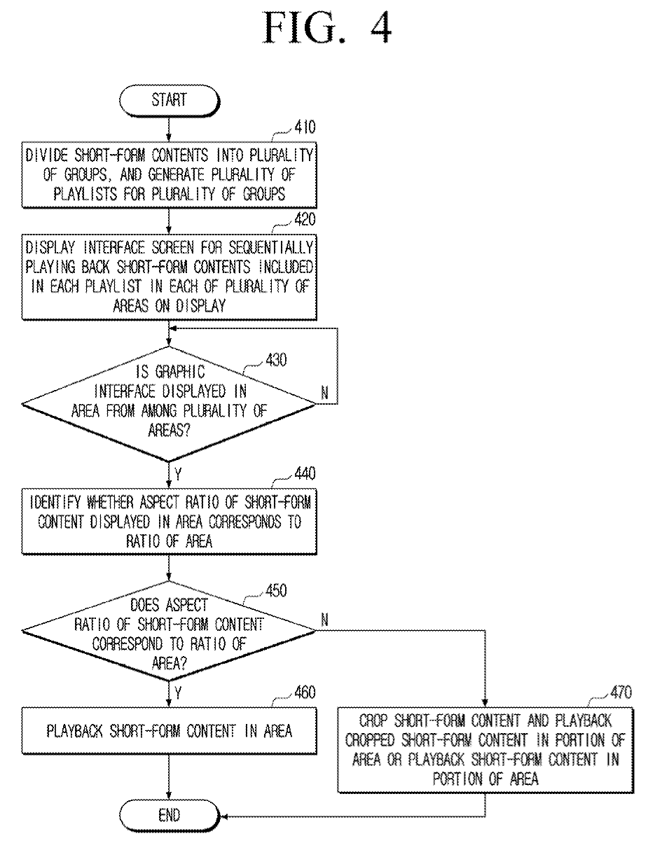

FIG. 4 is a flowchart illustrating an operation of the display apparatus 100 according to at least one embodiment of the disclosure. The processor 130 may perform at least one operation from among the operations of FIG. 4. The instructions stored in the memory 120, when executed individually or collectively by the processor 130, may cause the display apparatus 100 to perform the operations of FIG. 4.

In operation 410, the display apparatus 100 may divide a plurality of short-form contents into a plurality of groups, and generate a plurality of playlists for the plurality of groups.

As described above, the short-form content may be content of a short length associated with the original copy content. The original copy content associated with the short-form content may be the original copy content that becomes the basis of production of the short-form content. The short-form content may be content of a short length derived from the original copy content.

The memory 120 may store the short-form contents.

In some embodiments, the display apparatus 100 may request transmission of the short-form content to the server. The server may be a server that provides a streaming service for the original copy content. The server may transmit the short-form content for the original copy content to the display apparatus 100 at request. The display apparatus 100 may store the short-form content received from the server in the memory 120.

In some embodiments, the short-form content may be generated by the user. The user may produce the short-form content using the display apparatus 100 or a user device (e.g., a mobile device, a computer, etc.). The display apparatus 100 may store the generated short-form content in the memory 120, or receive the short-form content generated by the user device from the user device and store in the memory 120.

The display apparatus 100 may divide the plurality of short-form contents into the plurality of groups.

In an embodiment, the display apparatus 100 may use metadata of the plurality of short-form contents to divide the plurality of short-form contents into the plurality of groups.

Metadata may be data that includes information associated with the short-form content. The information associated with the short-form content may include information about the short-form content and/or information about the original copy content associated with the short-form content. For example, the information may include titles, production companies, cast members, themes, genres, ratings, award histories, and the like of the short-form content and the original copy content.

For example, the display apparatus 100 may obtain metadata from the server. The server may transmit, when transmitting the short-form content to the display apparatus 100, the metadata of the short-form content to the display apparatus 100.

For example, the metadata may be input by the user when the short-form content is generated by the user. For example, the display apparatus 100 or the user device may provide the interface through which information associated with the short-form content can be input when the user generates or after having generated the short-form content. The display apparatus 100 or the user device may transmit the metadata to the display apparatus 100.

The display apparatus 100 may divide the plurality of short-form contents into the plurality of groups for short-form contents having common metadata to be divided into one group.

For example, the display apparatus 100 may divide the plurality of short-form contents into the plurality of groups according to theme or genre. The display apparatus 100 may categorize the plurality of short-form contents into the plurality of groups for short-form contents having the same theme or same genre to belong in the same group. The short-form contents having the same theme or the same genre may include the short-form contents having the same theme or the same genre and/or the original copy contents associated with the short-form contents having the same theme or the same genre.

For example, the display apparatus 100 may divide the plurality of short-form contents into the plurality of groups according to cast member. The display apparatus 100 may categorize the plurality of short-form contents into the plurality of groups for short-form contents in which a same person appeared-in to belong in the same group. A same person appearing in the short-form content may include not only a when a person included in the short-form contents is the same, but also when a person who appeared-in the original copy contents associated with the short-form contents is the same.

However, the method of the display apparatus 100 dividing the plurality of short-form contents using metadata is not limited to the above-described examples. For example, the display apparatus 100 may categorize the plurality of short-form contents for the short-form contents associated with the original copy contents that have award histories to belong in the same group, or categorize the plurality of short-form contents for the short-form contents associated with the original copy contents produced by the same director or production company to belong in the same group.

In an embodiment, the display apparatus 100 may divide the plurality of short-form contents into the plurality of groups using history data of the user.

The history data may include information about content viewed by the user and/or content preferred by the user. The information may include, for example, a title of a content, a number of hits or preference indications (e.g., likes), and the like.

For example, the display apparatus 100 may categorize the plurality of short-form contents into the plurality of groups such that short-form contents associated with long-form contents whose number of times viewed by the user is greater than or equal to a preset number, or long-form contents for which the user has a viewing history, belong to the same group. Alternatively, the display apparatus 100 may categorize the plurality of short-form contents into the plurality of groups such that short-form contents whose number of times viewed by the user is greater than or equal to a preset number, or for which the user has a viewing history, belong to the same group.

For example, the display apparatus 100 may categorize the plurality of short-form contents into the plurality of groups for short-form contents associated with original copy contents preferred by the user to belong in the same group. Alternatively, the display apparatus 100 may categorize the plurality of short-form contents into the plurality of groups for short-form contents preferred by the user to belong in the same group.

However, the method of the display apparatus 100 categorizing the short-form contents is not limited to the above-described examples. For example, the display apparatus 100 may categorize the plurality of short-form contents using a method that is same as the method of categorizing content in OTT services, and the like.

In an embodiment, the display apparatus 100 may generate a plurality of playlists for the plurality of groups.

The playlist may include a list in which the short-form contents included in groups are lined-up according to a playback order.

For example, the display apparatus 100 may determine the playback order of the short-form contents in the playlist for each of the plurality of groups based on at least one from among aspect ratios and metadata of the plurality of short-form contents included in each of the plurality of groups.

An aspect ratio may be a ratio of a horizontal length and vertical length of an image. For example, an aspect ratio of the short-form content may be 16:9, 9:16, or 1:1. However, the disclosure is not limited thereto, and the short-form content may have various aspect ratios.

In an embodiment, the display apparatus 100 may identify a short-form content having a first playback order from among the short-form contents included in a group, identify the playback order of the remaining short-form contents, and determine the playback order of the short-form contents in the playlist for the group.

The display apparatus 100 may identify short-form contents having the most used aspect ratio based on aspect ratios of short-form contents included in the group. For example, the display apparatus 100 may identify, based on there being the short-form contents having an aspect ratio of 16:9 the most from among the short-form contents included in the group, the short-form content having an aspect ratio of 16:9.

In an embodiment, the display apparatus 100 may identify the short-form content having the first playback order from among the short-form contents identified based on the aspect ratio.

In an example, the display apparatus 100 may identify a short-form content with the highest relevance with the original copy content from among the short-form contents. The short-form contend being identified based on the aspect ratio. The short-form content with the highest relevance having the first playback order in the playlist. The display apparatus 100 may identify a relevance between the short-form content and the original copy content using metadata.

As described above, the metadata may include information about the short-form content and/or information about the original copy content associated with the short-form content. The display apparatus 100 may identify common information by comparing information about the original copy content and information about the short-form content, identify a relevance between the short-form content and the original copy content based on the common information, and identify the short-form content with the highest relevance as the short-form content of the first playback order. For example, the common information may identify, based on the titles, the production companies, the cast members, the themes, the genres, or the like of the short-form content and the original copy content being the same, information of the short-form content and the original copy content as common. The display apparatus 100 may identify the short-form content with the most number of common information as the short-form content with the highest relevance with the original copy content.

In an example, the display apparatus 100 may identify the short-form content with the most number of clicks from among the short-form contents having the first playback order in the playlist. The short-form contents identified based on the aspect ratio as the short-form content.

In an embodiment, the display apparatus 100 may identify the playback order of the remaining short-form contents. The remaining short-form contents may include the remaining short-form contents excluding the short-form content having the first playback order from among the short-form contents included in the group. For example, display apparatus 100 may determine the playback order of the remaining short-form contents in an order with the most common information with the original copy content. For example, the display apparatus 100 may determine the playback order of the remaining short-form contents in an order with the most number of clicks.

However, the method of the display apparatus 100 determining the playback order of the short-form contents is not limited to the above-described examples. For example, the display apparatus 100 may randomly determine the playback order of the short-form contents, or determine the playback order of the short-form contents in an order with the most recent production data of the short-form content.

In operation 420, the display apparatus 100 may display an interface screen for sequentially playing back the short-form contents included in each playlist in each of the plurality of areas on the display 110.

In an embodiment, the display apparatus 100 may display an interface screen for displaying the short-form contents included in each playlist on the display 110. As described above in FIG. 1, the interface screen may be a screen that provides content by categorizing according to category. The content may include the original copy content and/or the short-form content.

The interface screen may include a plurality of areas in which the plurality of contents are displayed. The content may include the short-form content and the original copy content. Thumbnails of the plurality of content may be displayed in the plurality of areas. A thumbnail may be a preview image of the content. An aspect ratio of a thumbnail may be same as an aspect ratio of a content. The thumbnail may be extracted by the display apparatus 100 from the content using a thumbnail extraction algorithm, or received from the server.

In an embodiment, the interface screen may include a plurality of areas in which the plurality of short-form contents is played back. The short-form content being played back in an area of the interface screen may include playing back the short-form content for a pre-set time, and providing a preview of the short-form content. Each of the plurality of areas may have the thumbnails of the short-form contents corresponding to the first playback order of each playlist displayed.

In an embodiment, the display apparatus 100 may display information about the plurality of playlists corresponding to the plurality of areas on the interface screen, respectively.

For example, the information about the playlist may include a title of the playlist. The title of the playlist may be related to a category that is the basis for categorizing the playlist. The display apparatus 100 may determine the title of the playlist based on the metadata. The display apparatus 100 may compare the metadata of the plurality of short-form contents included in the playlist, and determine information that is common from the plurality of short-form contents as the title of the playlist.

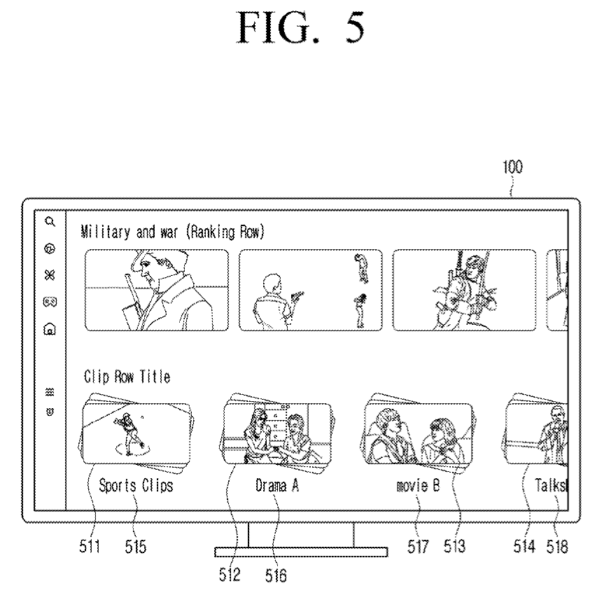

In an embodiment, the display apparatus 100 may display titles of a plurality of playlists corresponding to a plurality of areas in each of the areas adjacent with the plurality of areas. For example, the adjacent areas may be an upper area, a lower area, a left area, or a right area of the area. A specific example of the display apparatus 100 displaying a thumbnail and a title of the playlist in the area will be described below based on FIG. 5.

In operations 430 and 440, the display apparatus 100 may identify, based on a graphic interface being displayed in an area from among the plurality of areas, an aspect ratio of the short-form content displayed in the area as corresponding to a ratio of the area.

The graphic interface may be a graphic interface for selecting content displayed in an area. For example, the display apparatus 100 may display the graphic interface by using various methods such as, for example, and without limitation, displaying an edge portion of content displayed in an area in a different color, or display by highlighting the content, or adding a specific image such as an arrow mark, a cursor, or an indicator, or the like.

For example, the graphic interface may be automatically displayed on the interface screen when the interface screen is displayed on the display 110.

For example, the display apparatus 100 may display the graphic interface on the interface screen based on the user input, and move the graphic interface on the interface screen. The user input may be received from a remote control device (e.g., a user device capable of remotely controlling the display apparatus 100 through an application such as a smartphone or a tablet and/or a remote controller for controlling the display apparatus 100, etc.), or received through a button provided at the display apparatus 100. The display apparatus 100 may perform communication with remote control devices through communication methods such as, for example, and without limitation Wi-Fi communication, Bluetooth communication, infrared communication, and the like, using the communication circuitry 140. The user may select a direction key button provided at the remote control device and move the graphic interface to the top, bottom, left, and right. The display apparatus 100 may move, based on a user input for moving the graphic interface being received, a graphic interface displayed at one area from among the plurality of areas to an area positioned at the upper side, the lower side, the left side, or the right side of the area.

In an embodiment, the display apparatus 100 may display information about the short-form content displayed in the area. The information may be displayed in an area adjacent to the data using the graphic interface.

For example, the information about the short-form content may include at least one of a number of short-form contents in a playlist and a title of the short-form content being played back in the area. . The adjacent area may be an upper area, a lower area, a left area, or a right area of the area. In an example, the number may be displayed at the upper end of the area, and the title may be displayed at the lower end of the area. However, the disclosure is not limited thereto, and the number of the short-form contents and the title of the short-form content may be displayed at various positions.

In an embodiment, the display apparatus 100 may playback, when the graphic interface is displayed in the area from among the plurality of areas, the short-form content displayed in the area.

For example, the display apparatus 100 may display a plurality of thumbnail images in the plurality of areas. The plurality of thumbnail images may correspond to the plurality of short-form contents included in the plurality of playlists. The display apparatus 100 may playback at the area, based on the graphic interface being displayed in the area from among the plurality of areas, the short-form content corresponding to the thumbnail image displayed in the area.

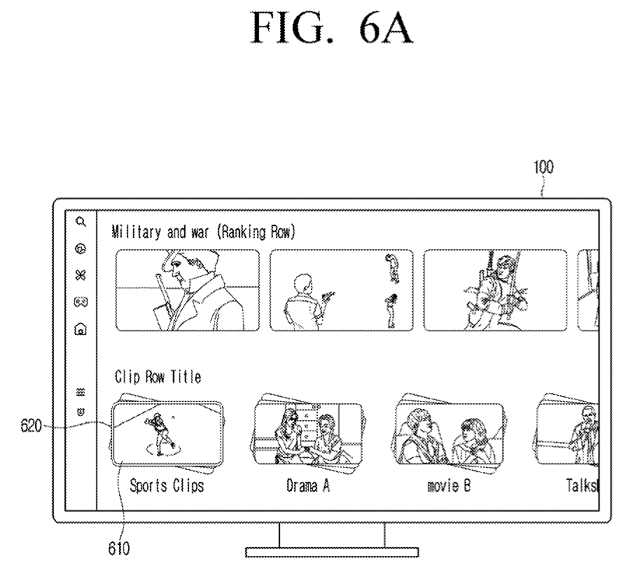

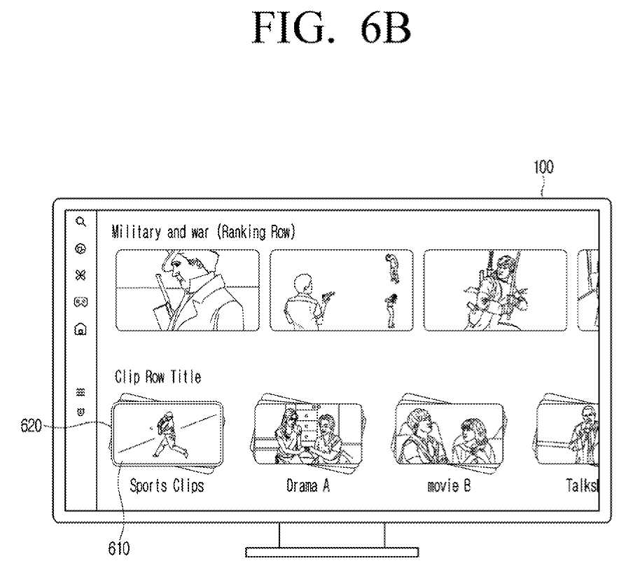

The short-form content being played back at the area may include playing back the short-form content for a pre-set time, and providing a preview of the short-form content. For example, the display apparatus 100 may playback, based on the graphic interface being displayed in an area from among the plurality of areas, a short-form content for a pre-set time . The short-form content may be played back corresponding to the first playback order. The first playback order may include short-form contents included in the playlist for the area. In an example, a pre-set time may be 10 seconds. However, the disclosure is not limited thereto. The pre-set time may be set at a default value, or set and changed by a user input. Specific examples of the display apparatus 100 providing a preview of the short-form content will be described below based on FIGS. 6A and 6B.

In some embodiments, in light of the display apparatus 100 sequentially providing previews of the short-form contents included in the playlist, user convenience may be increased.

In an embodiment, the display apparatus 100 may identify whether an aspect ratio of the short-form content displayed in the area corresponds to a ratio of the area. The short-form contents included in the playlist may have various aspect ratios. An aspect ratio of the short-form content may be an aspect ratio of an image of the short-form content. For example, the aspect ratio may be 16:9, 9:16, or 1:1. However, the disclosure is not limited thereto, and the short-form content may have various aspect ratios.

A ratio of an area may be determined based on an aspect ratio of the short-form content. The short-form content being first in a playback order of the playlist for the area.

The display apparatus 100 may identify the aspect ratio of the short-form content corresponding to the first playback order as the ratio of the area. The first playback order may be a first short-term content in a playlist.

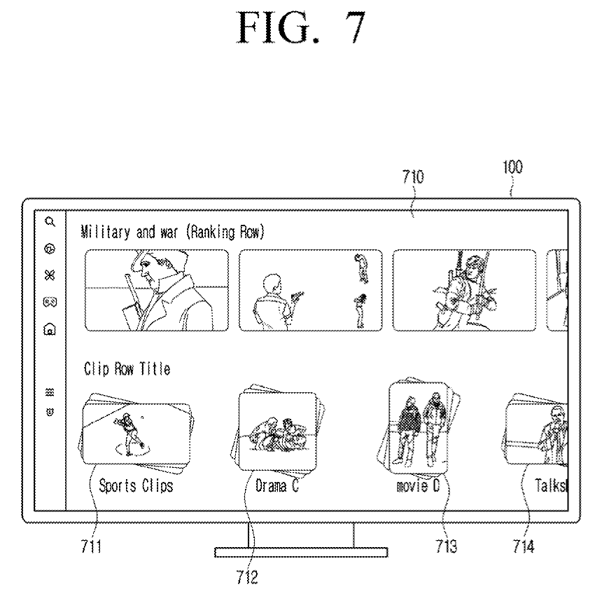

For example, the display apparatus 100 may determine, based on the aspect ratio of the short-form content corresponding to the first playback order being 1:1, the ratio of the area as 1:1. The display apparatus 100 may determine, based on the aspect ratio of the short-form content corresponding to the first playback order being 9:16, the ratio of the area as 9:16. The display apparatus 100 may determine, based on the aspect ratio of the short-form content corresponding to the first playback order being 16:9, the ratio of the area as 16:9. Specific examples of the various aspect ratios will be described below based on FIG. 7.

The display apparatus 100 may identify, based on the aspect ratio of the short-form content and the ratio of the area being the same, the aspect ratio of the short-form content as corresponding to the ratio of the area. For example, the display apparatus 100 may identify, based on the aspect ratio of the short-form content being 1:1 and the ratio of the area being 1:1, the aspect ratio of the short-form content as corresponding to the ratio of the area.

The display apparatus 100 may identify, based on the aspect ratio of the short-form content and the ratio of the area being different, the aspect ratio of the short-form content as not corresponding to the ratio of the area. For example, the display apparatus 100 may identify, based on the aspect ratio of the short-form content being 9:16 and the ratio of the area being 1:1, the aspect ratio of the short-form content as not corresponding to the ratio of the area.

In operations 450 and 460, the display apparatus 100 may playback, based on the aspect ratio of the short-form content corresponding to the ratio of the area, the short-form content in the area.

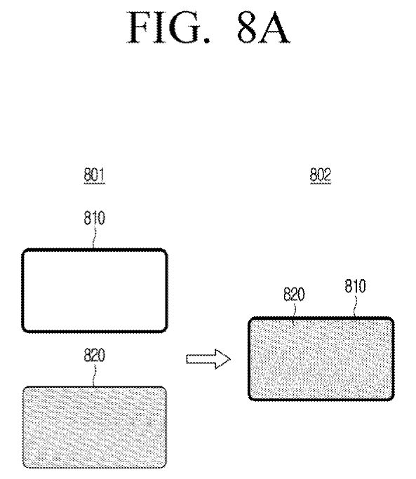

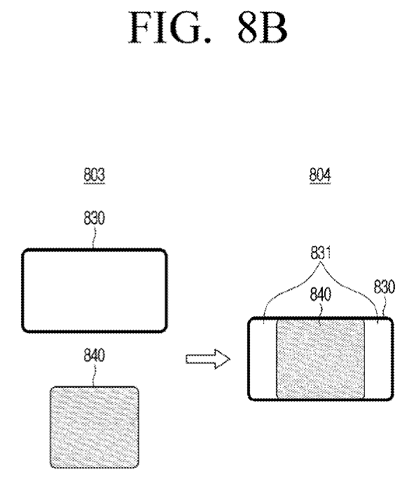

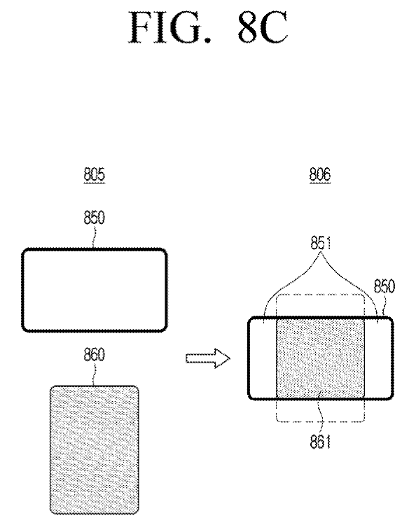

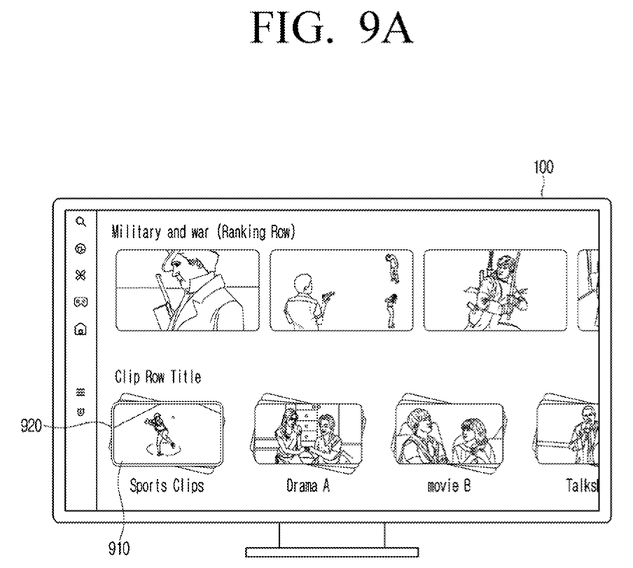

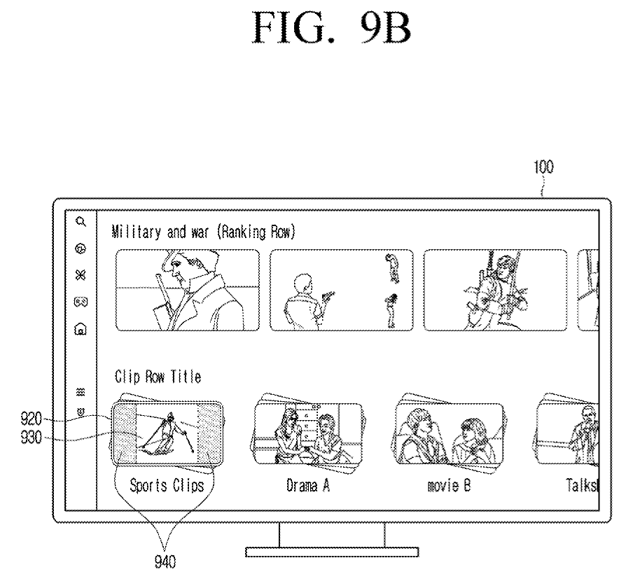

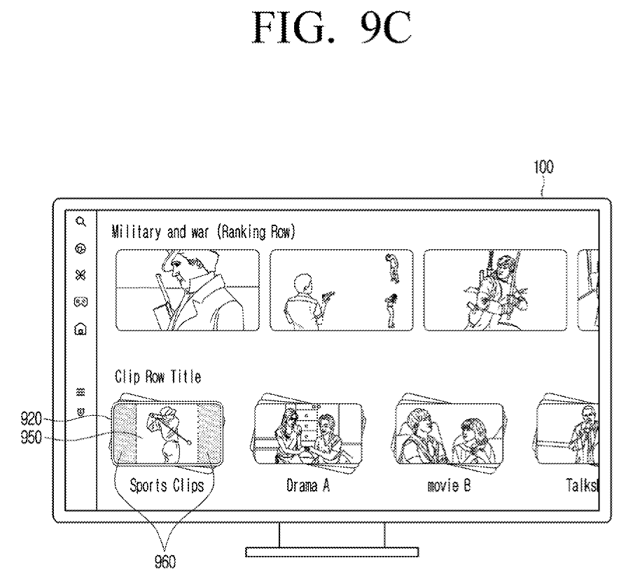

The display apparatus 100 may playback, based on the aspect ratio of the short-form content and the ratio of the area being the same, the short-form content in the area. Examples thereof will be described below based on FIGS. 8A and 9A.

In operations 450 and 470, the display apparatus 100 may crop, based on the aspect ratio of the short-form content not corresponding to the ratio of the area, the short-form content and playback the cropped short-form content in a portion of the area, or playback the short-form content in a portion of the area.

In an embodiment, the display apparatus 100 may playback the short-form content in a portion of the area, based on the aspect ratio of the short-form content not corresponding to the ratio of the area and the aspect ratio of the short-form content being a first aspect ratio. For example, the display apparatus 100 may display the short-form content in a portion of the area based on the aspect ratio of the short-form content and the ratio of the area being different from each other, and the aspect ratio of the short-form content corresponding to the first aspect ratio. The first aspect ratio may include an aspect ratio corresponding to a square. The first aspect ratio may include an aspect ratio of, for example, 1:1.

The display apparatus 100 may display a color in a portion of the area at which the short-form content is not displayed. The color may be determined based on a color of a short-form content.

The portion of the area at which the short-form content is not displayed may include an empty area that is generated by the short-form content being displayed in a portion of the area. For example, if the short-form content is displayed in a portion of the area, an empty area in the area may occur. An empty area may refer to a portion of an area that is not occupied by a short-form content.

For example, the display apparatus 100 may extract a main color of the short-form content, and display the main color at the empty area. The display apparatus 100 may analyze image frames included in the short-form content, and identify a main color of the short-form content. The main color may be a color used mainly in the short-form content. For example, the display apparatus 100 may extract the main color using K-means method or the like. The display apparatus 100 may display the main color in the empty area. The method by which the display apparatus 100 identifies the main color is not limited to the above-described example. For example, the display apparatus 100 may obtain the main color using an artificial intelligence model.

Examples of the display apparatus 100 playing back the short-form contents in a portion of the area will be described below based on FIGS. 8B and 9B.

In an embodiment, the display apparatus 100 may crop the short-form content and playback the cropped image in a portion of the area, based on the aspect ratio of the short-form content not corresponding to the ratio of the area, and the aspect ratio of the short-form content being a second aspect ratio. For example, the display apparatus 100 may crop the short-form content and display the same in a portion of the area based on the aspect ratio of the short-form content and the ratio of the area being different, and the aspect ratio of the short-form content corresponding to the second aspect ratio. The second aspect ratio may include an aspect ratio corresponding to a horizontal-type or a vertical-type. The second aspect ratio may include an aspect ratio of, for example, 16:9 or 9:16.

The cropping of the short-form content may include cropping a portion of an image of the short-form content. For example, the display apparatus 100 may crop the short-form content using the artificial intelligence model. The artificial intelligence model may be trained to crop the image for an object included in the image to be included in the cropped image. The object may be an element of the image such as, for example, and without limitation, a person, an object, an animal, a plant, and the like.

The artificial intelligence model may be generated through machine learning. The learning described above may be performed, for example, in the display apparatus 100 itself in which the artificial intelligence model is performed, or performed through a separate server. A learning algorithm may include, for example, a supervised learning, an unsupervised learning, a semi-supervised learning, or a reinforcement learning, but is not limited to the above-described examples. The artificial intelligence model may include a plurality of artificial neural network layers. An artificial neural network may be one from among a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-networks, or one from among two or more combination of the above, but is not limited to the above-described examples. The artificial intelligence model may include, additionally or alternatively, a software structure in addition to a hardware structure. In the disclosure, the artificial intelligence model may be stored in the memory 120, and may be implemented in a form of an on-device. Alternatively, the artificial intelligence model may be stored in the server connected with the display apparatus 100. If the artificial intelligence model is stored in the server, the display apparatus 100 may communicate with the server through the communication circuitry 140 in order to use the artificial intelligence model.

The display apparatus 100 may input the short-form content into the artificial intelligence model, and obtain the cropped short-form content. An object may be included in the cropped short-form content. A whole form of the object may be included in the cropped short-form content, or only a portion of the object may be included. For example, if a person is included in the short-form content, a face of the person may be included in the cropped short-form content. If an object, an animal, or a plant is included in the short-form content, the cropped short-form content may include characteristic portions (e.g., a face of the animal, a leaf, a flower, a fruit, and the like of the plant) of the object, the animal, or the plant.

In an embodiment, an aspect ratio of the cropped short-form content may be different from an aspect ratio of the area. For example, the aspect ratio of the cropped short-form content nay be 1:1, and the aspect ratio of the area may be 16:9. The cropped short-form content may be displayed at a portion of the area. The display apparatus 100 may display a color in an empty area determined based on a color of the short-form content in a portion of the area. For example, the display apparatus 100 may extract a main color of the short-form content, and display the main color at an empty area. The empty area may be a portion of the area at which the short-form content is not displayed. Because the method by which the display apparatus 100 extracts the main color and displays the empty area is same as that described above, redundant descriptions thereof will be omitted.

Examples of the display apparatus 100 cropping the short-form content and displaying in a portion of the area will be described below based on FIGS. 8C and 9C.

In some embodiments, the display apparatus 100 may playback the short-form content in the area based on the aspect ratio of the short-form content and the ratio of the area. Accordingly, the user may view short-form contents of various sizes.

FIG. 5 is a diagram illustrating a method by which a display apparatus displays a thumbnail in an area according to at least one embodiment of the disclosure.

Referring to FIG. 5, an interface screen 510 may include a plurality of areas 511, 512, 513, and 514 for the short-form contents. The plurality of areas 511, 512, 513, and 514 may have the plurality of short-form contents corresponding respectively to a plurality of categorized groups. In each area 511, 512, 513, and 514, the thumbnail of the short-form content having the first playback order be displayed. For example, in an area 511, the thumbnail of the short-form content having the first playback order from among the short-form contents associated with sports clips may be displayed. In an area 512, the thumbnail of the short-form content having the first playback order from among the short-form contents associated with drama A may be displayed. In an area 513, the thumbnail of the short-form content having the first playback order from among the short-form contents associated with movie B may be displayed. In an area 514, the thumbnail of the short-form content having the first playback order from among the short-form contents associated with talk shows may be displayed.

In addition, a playlist corresponding to the area 511 may include the short-form content associated with sports. The display apparatus 100 may determine the title of the playlist as “sports clips”, and display “sports clips” 515 at a lower end of the area 511. A playlist corresponding to the area 512 may include short-form contents associated with drama A. The display apparatus 100 may determine the title of the playlist as “drama A”, and display “drama A” 516 at a lower end of the area 512. A playlist corresponding to the area 513 may include short-form contents associated with movie B. The display apparatus 100 may determine the title of the playlist as “movie B”, and display “movie B” 517 at a lower end of the area 513. A playlist corresponding to the area 514 may include short-form contents associated with talk shows. The display apparatus 100 may determine the title of the playlist as “talk show clips”, and display “talk show clips” 518 at a lower end of the area 514.

FIGS. 6A and 6B are diagrams illustrating an operation of an image displayed in an area being played back according to at least one embodiment of the disclosure.

Referring to FIGS. 6A and 6B, the display apparatus 100 may playback, based on a graphic interface 620 being displayed in an area 610 corresponding to sports clips, the short-form content corresponding to the first playback order from among the short-form contents included in sports clips for 10 seconds. The display apparatus 100 may playback a short-form content following the short-form content in the playlist at the area for a pre-set time (e.g., 10 seconds) after playing back the short-form content for the pre-set time. In other words, the display apparatus 100 may sequentially playback, while the graphic interface is being displayed in the area, the short-form contents included for the area in the area.

FIG. 7 is a diagram illustrating an area having various ratios according to at least one embodiment of the disclosure.

Referring to FIG. 7, an interface screen 710 may include a plurality of areas 711, 712 ,713, and 714 having various ratios. Areas 711 and 714 may have a ratio of 16:9. The area 712 may have a ratio of 1:1. The area 713 may have a ratio of 9:16. In each area 711, 712, 713, and 714, short-form contents included in each group may be played back.

FIGS. 8A to 8C are diagrams illustrating a method by which images of various aspect ratios are displayed in an area according to at least one embodiment of the disclosure. In addition, FIGS. 9A to 9C are diagrams illustrating specific examples in which images of various aspect ratios are displayed in an area according to at least one embodiment of the disclosure.

In an embodiment, the display apparatus 100 may playback, based on the aspect ratio of the short-form content and the ratio of the area being the same, the short-form content in the area.

For example, referring to 801 in FIG. 8A, a ratio of an area 810 may be 16:9, and an aspect ratio of a short-form content 820 may be 16:9. The ratio of the area 810 and the aspect ratio of the short-form content 820 may be the same. Referring to 802 in FIG. 8A, in the area 810, the short-form content 820 may be displayed in the area 810 without an empty area. As in FIG. 9A, a short-form content 910 in the interface screen may maintain an aspect ratio of 16:9 and played back in an area 920 having a ratio of 16:9.

In an embodiment, the display apparatus 100 may playback, based on the aspect ratio of the short-form content not corresponding to the ratio of the area, the short-form content in a portion of the area.

For example, referring to 803 in FIG. 8B, a ratio of an area 830 may be 16:9, and an aspect ratio of a short-form content 840 may be 1:1. The ratio of the area 830 and the aspect ratio of the short-form content 840 may be different. Referring to 804 in FIG. 8B, the short-form content 840 may be displayed in a portion of the area 830. When the short-form content 840 is displayed in the portion of the area 830, an empty area 831 may be generated. The display apparatus 100 may extract a main color of the short-form content and display the main color in the empty area 831. As in FIG. 9B, a short-form content 930 having an aspect ratio of 1:1 on the interface screen may be played back in a portion of an area 920 having a ratio of 16:9. The display apparatus 100 may extract, in order to fill in an empty area 940 of the area 920, a main color of the short-form content 930, and display the main color at the empty area 940. For example, if the main color of the short-form content 930 is black, the empty area 940 may be displayed as black.

In an embodiment, the display apparatus 100 may crop, based on the aspect ratio of the short-form content not corresponding to the ratio of the area, the short-form content and playback the cropped short-form content in a portion of the area.

For example, referring to 805 in FIG. 8C, a ratio of an area 850 may be 16:9, and an aspect ratio of a short-form content 860 may be 9:16. The ratio of the area 850 and the aspect ratio of the short-form content 860 may be different. Referring to 806 in FIG. 8C, the display apparatus 100 may crop the short-form content 860 in order to display the short-form content 860 in the area 850. A cropped short-form content 861 may be displayed in a portion of the area 830. When the cropped short-form content 861 is displayed at the portion of the area 830, an empty area 851 may be generated. The display apparatus 100 may extract a main color of the short-form content and display the main color at the empty area 851. As in FIG. 9C, a short-form content having an aspect ratio of 9:16 may be cropped, and a cropped short-form content 950 having an aspect ratio of 1:1 may be generated. The cropped short-form content 950 having the aspect ratio of 1:1 may be played back in a portion of an area 920 having a ratio of 16:9. The display apparatus 100 may extract a main color of the short-form content in order to fill in an empty area 960 of the area 920, and display the empty area 960 with the main color. For example, if the main color of the short-form content is white, the empty area 960 may be displayed as white.

In an embodiment, the display apparatus 100 may playback, based on a user input for selecting an area in which the graphic interface is displayed being received, the short-form content displayed in the area on the screen of the display 110.

For example, the user input may be received from the remote control device, or received through a button provided at the display apparatus 100. The user may use the button provided at the remote control device or the display apparatus 100, and select an area at which the graphic interface is displayed. The display apparatus 100 may playback, based on a user input for selecting the area at which the graphic interface is displayed being received, the short-form content displayed in the area on the screen of the display 110. For example, the display apparatus 100 may playback the short-form content in one area of the screen. The short-form content played back in one area of the screen may be such that the whole of the short-form content is played back rather than the preview of the short-form content. A size of the one area of the screen in which the short-form content is played back may be greater than a size of the area in which the short-form content has been displayed on the above-described interface screen. A ratio of the one area of the screen in which the short-form content is played back may be the same as with the aspect ratio of the short-form content.

For example, the display apparatus 100 may display at the remaining area of the screen at least one from among information about the short-form content and an interface element. The information about the short-form content may include a title of a playlist in which the short-form content is included or a title of a short-form content. The interface element may include at least one from among a progress bar for the short-form content, an interface element for playing back an image associated with the short-form content, and an interface element for inputting a preference indication about the short-form content.

The progress bar may be an interface element that indicates an extent a playing back of the short-form content has progressed. The progress bar may be automatically displayed when the short-form content is played back in one area of the screen. Alternatively, when a user input for the short-form content is received, the progress bar may be displayed. The user may select, to change a playback time-point of the short-form content through the progress bar, a button provided at the display apparatus 100 or the remote control device. The display apparatus 100 may change the playback time-point of the short-form content based on a user input. The progress bar may be displayed for a pre-set time. For example, the display apparatus 100 may stop, based on a user input not being received for a pre-set time from a time-point at which the progress bar is displayed or from a time-point a user input for the progress bar is received, the display of the progress bar.

The interface element for playing back an image associated with the short-form content may be an interface element for displaying a page about the original copy content associated with the short-form content. The display apparatus 100 may display, based on a user input for selecting the interface element being received, a page for the original content on the screen. The user input may be received through the display apparatus 100 or the remote control device. The page of the original copy content may be included with basic information (e.g., characters, synopsis, genre, etc.) of the original copy content and an interface element for playing back the original copy content.

The interface element for inputting a preference indication may be an interface element for receiving input of a preference of the user for the short-form content. The display apparatus 100 may store, based on a user input for selecting the interface element being received, user preference information about the short-form content being played back in the memory 120. The display apparatus 100 may generate a playlist based on the preference information about the short-form contents. For example, the display apparatus 100 may generate, based on “actor BB” appearing in the short-form contents input with the preference indication, a playlist consisting of short-form contents that actor “BB” appeared in. However, the disclosure is not limited thereto. For example, the display apparatus 100 may generate a playlist consisting of short-form contents input with the preference indication.

As described in FIG. 9A, the display apparatus 100 may playback the short-form content included in the area at which the graphic interface is positioned, and provide the user with a preview of the short-form content.

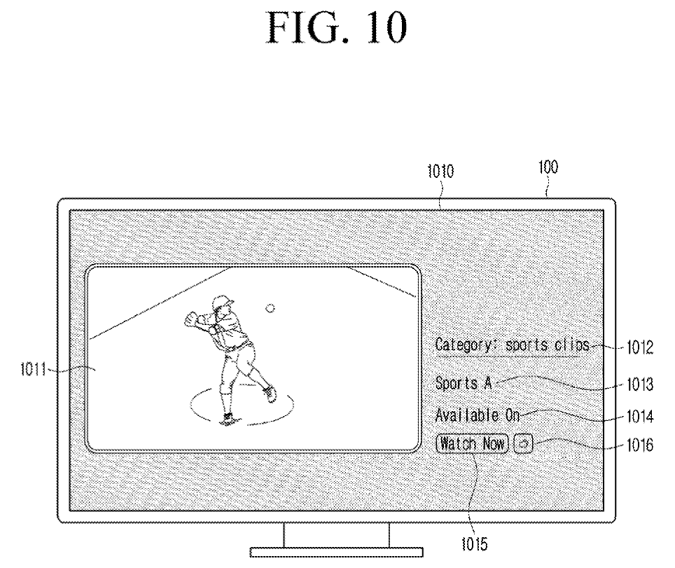

As in FIG. 10, the display apparatus 100 may playback, based on a user input for selecting an area at which the graphic interface is displayed being received, a short-form content 1011 on the screen 1010. An aspect ratio of the short-form content 1011 may be 16:9. The display apparatus 100 may playback the short-form content 1011 in an area having a ratio of 16:9. The display apparatus 100 may display a title 1012 of a playlist in which the short-form content 1011 (e.g., sports clips) is included, and a title 1013 of the short-form content 1011 (e.g., Sports A). The display apparatus 100 may display, if the original copy content associated with the short-form content 1011 is streamable from an OTT platform, a text 1014 indicating that the short-form content 1011 is viewable from the OTT platform and a button 1015 (e.g., Watch Now) for playing back the original copy content. The display apparatus 100 may display a button 1016 for receiving input of the preference indication about the short-form content 1011.

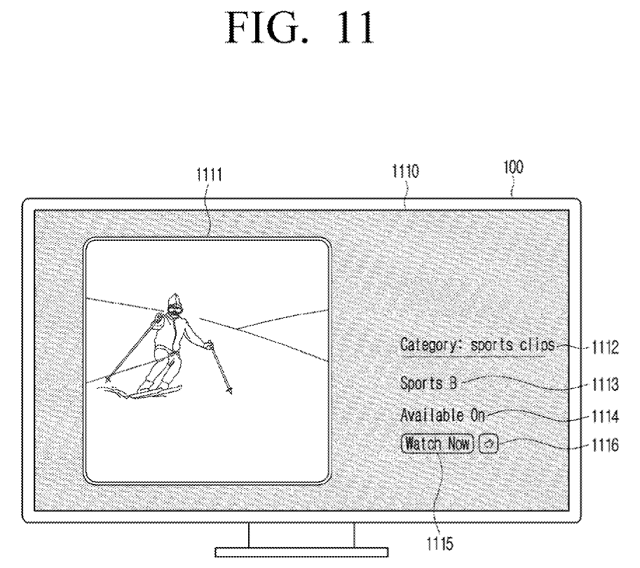

In an example, as in FIG. 11, the display apparatus 100 may playback, based on a user input for selecting an area in which the graphic interface is displayed being received, a short-form content 1111 on the screen 1110. An aspect ratio of the short-form content 1111 may be 1:1. The display apparatus 100 may playback the short-form content 1111 in an area having a ratio of 1:1.

The display apparatus 100 may display a title 1112 of a playlist in which the short-form content 1111 (e.g., sports clips) is included, and a title 1113 of the short-form content 1111 (e.g., Sports B). As described above, the display apparatus 100 may display a text 1114 indicating that the short-form content 1111 is viewable from an OTT platform, a button 1115 for playing back the original copy content, and a button 1116 for receiving input of preference indication about the short-form content 1111.

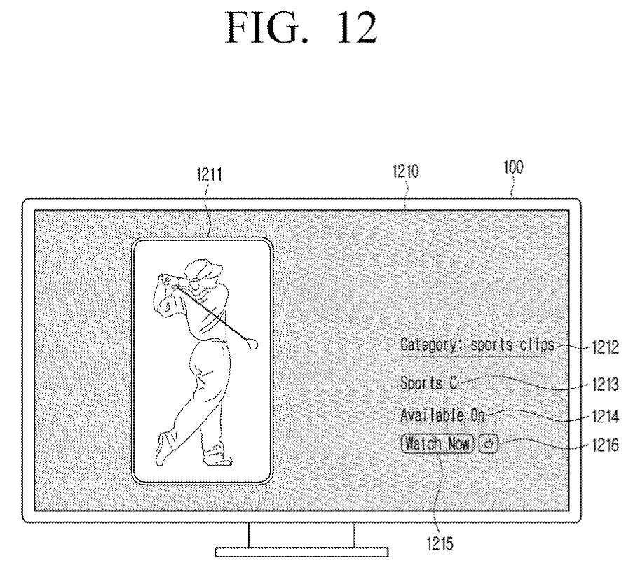

In an example, as in FIG. 12, the display apparatus 100 may playback, based on a user input for selecting an area in which the graphic interface is displayed being received, a short-form content 1211 on the screen 1210. An aspect ratio of the short-form content 1211 may be 9:16. The display apparatus 100 may playback the short-form content 1211 in an area having a ratio of 1:1.

The display apparatus 100 may display a title 1212 of a playlist in which the short-form content 1211 is included (e.g., sports clips), and a title 1213 of the short-form content 1211 (e. g., Sports C). As described above, the display apparatus 100 may display a text 1214 indicating that the short-form content 1211 is viewable from an OTT platform, a button 1215 for playing back the original copy content, and a button 1216 for receiving input of preference indication about the short-form content 1211.

In an embodiment, the display apparatus 100 may display, based on a user input for playing back a different short-form content from the short-form content being played back being received, the different short-form content in an area. The different short-form content may be a short-form content included in the same playlist as the short-form content being played back, or a short-form content included in a different playlist from the short-form content being played back.

For example, the user input may be received from the remote control device, or received through a button provided at the display apparatus 100. The user may select the direction key button provided at the remote control device or the display apparatus 100, and input a user input for playing back the different short-form content.

In an example, the display apparatus 100 may playback, based on a user input for playing back a short-form content different from the short-form content being received, the different short-form content included in the playlist in which the short-form content is included on the screen. The user may select a first direction key button or a second direction key button which is opposite of the first direction key button provided at the remote control device or the display apparatus 100. For example, a first direction may be an upper direction, and a second direction may be a lower direction. The display apparatus 100 may playback, based on a user input for selecting the first direction key button being received, a short-form content having a playback order following a playback order of the short-form content on the playlist in which the short-form content being played back is included on the screen. The display apparatus 100 may playback, based on a user input for selecting the second direction key button being received, a short-form content having a playback order prior to a playback order of the short-form content on the playlist in which the short-form content being played back is included on the screen.

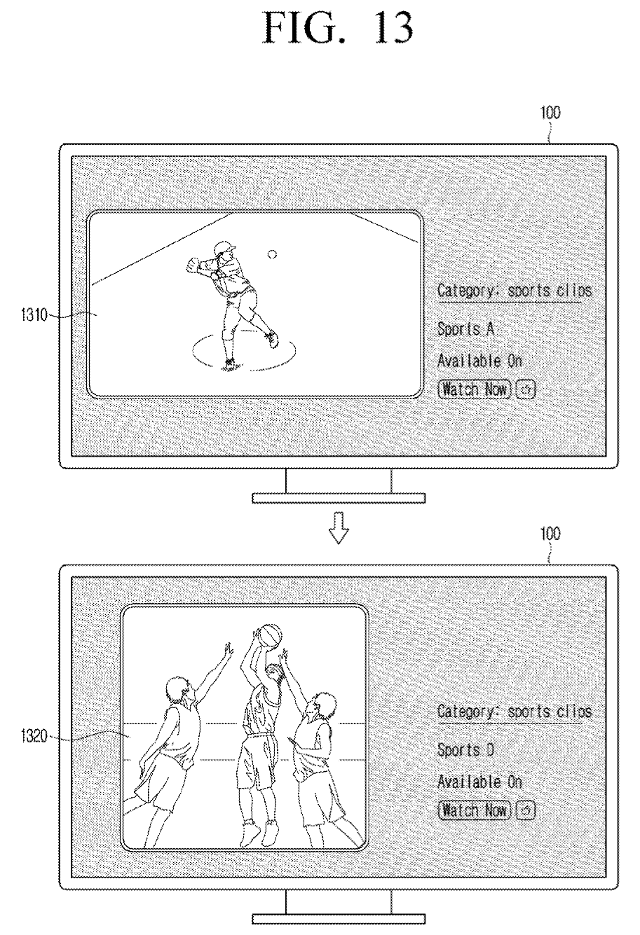

For example, referring to FIG. 13, the display apparatus 100 may playback a short-form content 1310 in an area having a ratio of 16:9 in an area of the screen. The short-form content 1310 may be a short-form content included in sports clips. The display apparatus 100 may playback and display a different short-form content 1320 included in a playlist about sports clips based on a user input for selecting the first direction key button or the second direction key button being received. For example, if an aspect ratio of the short-form content 1320 is 1:1, the display apparatus 100 may playback the short-form content 1320 in an area having a ratio of 1:1.

In an example, the display apparatus 100 may playback, based on a user input for playing back a short-form content different from the short-form content being received, the different short-form content included in a different playlist in which the short-form content is not included on the screen. The user may select a third direction key button or a fourth direction key button opposite of the third direction key button provided at the remote control device or the display apparatus 100. For example, the third direction may be a right direction, and the fourth direction may be a left direction. The display apparatus 100 may playback, based on a user input for selecting the third direction key button being received, a short-form content included in a playlist corresponding to a following playback order of the playlist in which the short-form content being played back is included on the screen. The display apparatus 100 may playback, based on a user input for selecting the fourth direction key button being received, a short-form content included in a playlist corresponding to a previous playback order of the playlist in which the short-form content being played back is included on the screen.

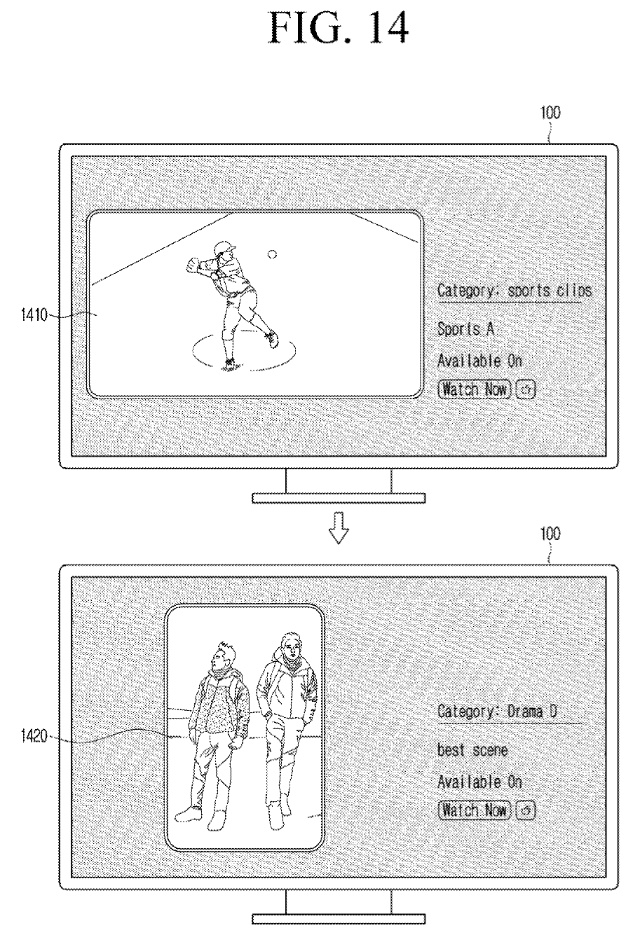

For example, referring to FIG. 14, the display apparatus 100 may playback a short-form content 1410 in an area having a ratio of 16:9 in an area of the screen. The short-form content 1410 may be a short-form content included in sports clips. The display apparatus 100 may playback and display a different short-form content 1420 included in a different playlist that is not associated with the sports clips based on a user input for selecting the third direction key button or the fourth direction key button being received. For example, the short-form content 1420 may be content included in a playlist about movie D.

If an aspect ratio of the short-form content 1420 is 9:16, the display apparatus 100 may playback the short-form content 1420 in an area having a ratio of 9:16.

In the above, each of the various embodiments have been described, but each of the embodiments are not necessarily implemented individually, and may be combined as a whole or partially with at least one of other embodiments and implemented together in one product.

Embodiments of the disclosure may also be implemented in a form of a recording medium that includes instructions executable by a computer such as a program module executed by the computer. A computer-readable medium may be any available medium that can be accessed by the computer, and may include both a volatile and non-volatile media, and a removable and non-removable medium. In addition, the computer-readable medium may include a computer storage medium and a communication medium. The computer storage medium may be a random method or technology for storing information such as computer-readable instructions, data structures, program modules, or other data, and may include both a volatile and non-volatile medium, and a removable and non-removable medium. The communication medium may typically include other data of a modulated data signal such as computer-readable instructions, data structures, or program modules.

In addition, the storage medium readable by the computer may be provided in a form of a non-transitory storage medium. Here, the ‘non-transitory storage medium’ is a tangible device, and merely means that the storage medium does not include a signal (e.g., electromagnetic waves), and the term does not differentiate data being semi-permanently stored or being temporarily stored in the storage medium. In an example, the ‘non-transitory storage medium’ may include a buffer in which data is temporarily stored.

According to an embodiment, a method according to the various embodiments described in the disclosure may be provided included a computer program product. The computer program product may be exchanged between a seller and a purchaser as a commodity. The computer program product may be distributed in a form of a machine-readable storage medium (e.g., a compact disc read only memory (CD-ROM)), or distributed online (e.g., downloaded or uploaded) through an application store or directly between two user devices (e.g., smartphones). In the case of online distribution, at least a portion of the computer program product (e.g., downloadable app) may be stored at least temporarily in the machine-readable storage medium such as a server of a manufacturer, a server of an application store, or a memory of a relay server, or temporarily generated.

The above-described descriptions of the disclosure are provided as examples, and it will be understood by those of ordinary skill in the art that various modifications can be made to the embodiments in different specific forms without departing from the technical spirit or the essential features of the disclosure. Accordingly, the embodiments described above are to be understood as examples in all aspect and not limiting. For example, each element described as a singular type may be distributed and implemented, and likewise, elements described as distributed may also be implemented in a combined form.

The scope of the disclosure is represented by the claims below rather than the detailed description above, it will be understood that all modifications or changed forms derived from the meaning and scope of the claims and equivalent concept thereof are included in the scope of the disclosure.

What is claimed is:

1. A display apparatus comprising:
a display;
memory storing instructions; and
at least one processor comprising processing circuitry,
wherein the instructions, when executed by the at least one processor individually or collectively, cause the display apparatus to:
divide a plurality of short-form contents into a plurality of groups,
generate a plurality of playlists, wherein each playlist of the plurality of playlists corresponds to a group of the plurality of groups,
display an interface screen for sequentially playing back short-form contents included in each playlist of the plurality of playlists, wherein each playlist of the plurality of playlists corresponds to an area of a plurality of areas of the interface screen on the display,
identify, based on a graphic interface being displayed in an area of the plurality of areas, whether an aspect ratio of a short-form content displayed in the area corresponds to a ratio of the area, and
based on the aspect ratio of the short-form content corresponding to the ratio of the area, playback the short-form content in the area, and
based on the aspect ratio of the short-form content not corresponding to the ratio of the area, (i) crop the short-form content and playback the cropped short-form content in a portion of the area, or (ii) playback the short-form content in a portion of the area.

2. The display apparatus of claim 1, wherein the instructions, when executed by the at least one processor individually or collectively, cause the display apparatus to:
based on the aspect ratio of the short-form content and the ratio of the area being the same, identify the aspect ratio of the short-form content as corresponding to the ratio of the area, or
based on the aspect ratio of the short-form content and the ratio of the area being different, identify the aspect ratio of the short-form content as not corresponding to the ratio of the area.

3. The display apparatus of claim 1, wherein the instructions, when executed by the at least one processor individually or collectively, cause the display apparatus to:
based on the aspect ratio of the short-form content not corresponding to a ratio of the area, and the aspect ratio of the short-form content being a first aspect ratio, playback the short-form content in a portion of the area, and
based on the aspect ratio of the short-form content not corresponding to a ratio of the area, and the aspect ratio of the short-form content being a second aspect ratio, crop the short-form content and playback the cropped short-form content in a portion of the area.

4. The display apparatus of claim 1, wherein the instructions, when executed by the at least one processor individually or collectively, cause the display apparatus to:
input the short-form content into a trained artificial intelligence model to crop the short-form content such that an object included in the short-form content is to be included in the cropped short-form content, and obtain the cropped short-form content from the artificial intelligence model.

5. The display apparatus of claim 1, wherein the instructions, when executed by the at least one processor individually or collectively, cause the display apparatus to:
display a plurality of thumbnail images in the plurality of areas, wherein each thumbnail image of the plurality of thumbnail images corresponds to a short-form content included in the plurality of playlists, and
based on the graphic interface being displayed in the area, playback the short-form content which corresponds to a thumbnail image displayed in the area at the area.

6. The display apparatus of claim 1, wherein the instructions, when executed by the at least one processor individually or collectively, cause the display apparatus to:
playback, while the graphic interface is being displayed in the area, the short-form content for a pre-set time, wherein the short-form content is included in a playlist of the plurality of playlists, and
after the pre-set time, playback a second short-form content in the area, wherein the second short-form content is included in the playlist.

7. The display apparatus of claim 1, wherein the instructions, when executed by the at least one processor individually or collectively, cause the display apparatus to:
based on the graphic interface being displayed in the area, display at least one from among a number of short-form contents included in a playlist corresponding to the area and a title of a short-form content being played back in the area on a short-form content displayed in the area .

8. The display apparatus of claim 1, wherein the instructions, when executed by the at least one processor individually or collectively, cause the display apparatus to:
based on a user input for selecting the area in which the graphic interface is displayed being received, playback the short-form content displayed in the area on a screen of the display.

9. The display apparatus of claim 8, wherein the instructions, when executed by the at least one processor individually or collectively, cause the display apparatus to:
display at least one from among a title of a playlist in which the short-form content is included, a title of the short-form content, a progress bar for the short-form content, an interface element for playing back an image associated with the short-form content, and an interface element for inputting a preference indication about the short-form content on the screen.

10. The display apparatus of claim 1, wherein the instructions, when executed by the at least one processor individually or collectively, cause the display apparatus to:
based on a user input for playing back another short-form content that is different from the short-form content being received, playback a second short-form content included in a first playlist in which the short-form content is included on a screen of the display, or playback a third short-form content included in a second playlist that is different from the first playlist on the screen.

11. A control method of a display apparatus, the control method comprising:
dividing a plurality of short-form contents into a plurality of groups;
generating a plurality of playlists, wherein each playlist of the plurality of playlists corresponds to a group of the plurality of groups;
displaying an interface screen for sequentially playing back short-form contents comprised in each playlist of the plurality of playlists, wherein each playlist of the plurality of playlists corresponds to an area of a plurality of areas of the interface screen on a display;
based on a graphic interface being displayed in an area of the plurality of areas, identifying whether an aspect ratio of a short-form content displayed in the area corresponds to a ratio of the area;
based on the aspect ratio of the short-form content corresponding to the ratio of the area, playing back the short-form content in the area; and
based on the aspect ratio of the short-form content not corresponding to the ratio of the area, (i) cropping the short-form content and playing back the cropped short-form content in a portion of the area or (ii) playing back the short-form content in a portion of the area.

12. The control method of claim 11, wherein the identifying whether the aspect ratio of the short-form content displayed in the area corresponds to the ratio of the area comprises:
based on the aspect ratio of the short-form content and the ratio of the area being the same, identifying the aspect ratio of the short-form content as corresponding to the ratio of the area; and
identifying, based on the aspect ratio of the short-form content and the ratio of the area being different, the aspect ratio of the short-form content as not corresponding to the ratio of the area.

13. The control method of claim 11, wherein the playing back the short-form content in a portion of the area, or cropping the short-form content and playing back the cropped short-form content in a portion of the area comprises:
based on the aspect ratio of the short-form content not corresponding to the ratio of the area and the aspect ratio of the short-form content being a first aspect ratio, playing back the short-form content in the portion of the area, and
based on the aspect ratio of the short-form content not corresponding to the ratio of the area and the aspect ratio of the short-form content being a second aspect ratio, cropping the short-form content and playing back the cropped short-form content in the portion of the area.

14. The control method of claim 11, wherein the cropping the short-form content comprises inputting the short-form content into a trained artificial intelligence model to crop the short-form content such that an object included in the short-form content is to be included in the cropped short-form content.

15. The control method of claim 11, further comprising:
displaying a plurality of thumbnail images in the plurality of areas, wherein each thumbnail image of the plurality of thumbnail images corresponds to a short form content included in the plurality of playlists, and
based on the graphic interface being displayed in the area, playing back the short-form content which corresponds to a thumbnail image displayed in the area at the area.

16. A non-transitory computer-readable recording medium that stores one or more instructions executed by a processor of a display apparatus to cause the display apparatus to perform a method comprising:
dividing a plurality of short-form contents into a plurality of groups;
generating a plurality of playlists, wherein each playlist of the plurality of playlists corresponds to a group of the plurality of groups;
displaying an interface screen for sequentially playing back short-form contents comprised in each playlist of the plurality of playlists, wherein each playlist of the plurality of playlists corresponds to an area of a plurality of areas of the interface screen on a display;
based on a graphic interface being displayed in an area of the plurality of areas, identifying whether an aspect ratio of a short-form content displayed in the area corresponds to a ratio of the area;
based on the aspect ratio of the short-form content corresponding to the ratio of the area, playing back the short-form content in the area; and
based on the aspect ratio of the short-form content not corresponding to the ratio of the area, (i) cropping the short-form content and playing back the cropped short-form content in a portion of the area or (ii) playing back the short-form content in a portion of the area.

17. The non-transitory computer-readable recording medium of claim 16, wherein the identifying whether the aspect ratio of the short-form content displayed in the area corresponds to the ratio of the area comprises:
based on the aspect ratio of the short-form content and the ratio of the area being the same, identifying the aspect ratio of the short-form content as corresponding to the ratio of the area; and
identifying, based on the aspect ratio of the short-form content and the ratio of the area being different, the aspect ratio of the short-form content as not corresponding to the ratio of the area.

18. The non-transitory computer-readable recording medium of claim 16, wherein the playing back the short-form content in a portion of the area, or cropping the short-form content and playing back the cropped short-form content in a portion of the area comprises:
based on the aspect ratio of the short-form content not corresponding to the ratio of the area and the aspect ratio of the short-form content being a first aspect ratio, playing back the short-form content in the portion of the area, and
based on the aspect ratio of the short-form content not corresponding to the ratio of the area and the aspect ratio of the short-form content being a second aspect ratio, cropping the short-form content and playing back the cropped short-form content in the portion of the area.

19. The non-transitory computer-readable recording medium of claim 16, wherein the cropping the short-form content comprises inputting the short-form content into a trained artificial intelligence model to crop the short-form content such that an object included in the short-form content is to be included in the cropped short-form content.

20. The non-transitory computer-readable recording medium of claim 11, wherein the method further comprises:
displaying a plurality of thumbnail images in the plurality of areas, wherein each thumbnail image of the plurality of thumbnail images corresponds to a short form content included in the plurality of playlists, and
based on the graphic interface being displayed in the area, playing back the short-form content which corresponds to a thumbnail image displayed in the area at the area.
